(19) United States
(12) Patent Application Publication
(10) Pub. No.: US 2009/0001958 A1
(43) Pub. Date: Jan. 1, 2009

(54) Bandgap circuit

(75) Inventor: Yasunori Fujii, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/155,497

(22) Filed: Jun. 5, 2008

(30) Foreign Application Priority Data
Jun. 7, 2007 (JP) 2007-151523

(51) Int. Cl. G05F 3/16

(52) U.S. Cl. 323/313

(57) ABSTRACT

A bandgap circuit according to an embodiment of the present invention includes a load circuit arranged between an output terminal and a first power supply line, an output transistor arranged between the output terminal and a second power supply line, and outputs a desired reference voltage in accordance with control voltage, a control voltage generating circuit generating the control voltage applied to the output transistor, and a filter arranged between the output transistor and the control voltage generating circuit.

### BACKGROUND OF THE INVENTION

1. Field of the Invention

The present invention relates to a bandgap circuit, and more particularly, to a bandgap circuit generating a reference voltage used in a semiconductor device.

2. Description of Related Art

A bandgap circuit has widely been used as a power supply circuit capable of generating voltage or current constantly without being affected by a power supply voltage fluctuation or temperature fluctuation in generating a reference voltage in a semiconductor device. One example of such a bandgap circuit is disclosed in Japanese Unexamined Patent Application Publication Nos. 2005-173905 and 2000-267749.

FIG. 6 shows a circuit diagram of a bandgap circuit 100 disclosed in Japanese Unexamined Patent Application Publication No. 2005-173905. Hereinafter, this bandgap circuit will be described. The bandgap circuit 100 includes MOS transistors M101 to M103, PNP transistors Q101 to Q103, resistors R102 and R103, and an amplifier 101. A transistor size ratio of the MOS transistors M101 to M103 (a ratio of a value indicated by a gate width W/a gate length L) is set so that M101:M102:M103=1:1:M, and a transistor size ratio of the PNP transistors Q101 to Q103 (a ratio of an emitter area) is set so that Q101:Q102:Q103=1:N:M. The bandgap circuit 100 generates current I proportional to an absolute temperature by operations of the MOS transistors M101 and M102, the PNP transistors Q1 and Q2, the resistor R102, and the amplifier 101. Then the bandgap circuit 100 flows current which is obtained by multiplying the current I by the transistor size ratio M of the MOS transistor M103 in the resistor R103 and the PNP transistor Q103, whereby an output voltage Vout indicated by the expression (1) can be obtained:

$$\begin{matrix}Vout = VBE 3 + R 3 \times M \times I \\ = VBE 3 + R 3 \times M \times \frac{1}{R 2} \times \frac{kT}{q} \times ln N\end{matrix} \qquad ( 1 )$$

wherein VBE3 is a voltage between a base and an emitter of the PNP transistor Q103, k is Boltzmann constant, T is an absolute temperature, and q is an elementary charge. VBE3 has a negative temperature coefficient (about −2 mV/K), and the second term has a positive temperature coefficient. Accordingly, constant output voltage can be supplied with respect to the temperature by making the coefficients of the first term and the second term in the above expression (1) equal to each other. Since the expression (1) has no term including the power supply voltage, constant output voltage Vout can be supplied with respect to the power supply voltage as well.

However, in the transistor or the resistor formed on the semiconductor substrate, the device itself can cause a noise (hereinafter a noise caused by the device itself will be referred to as device noise). Since the bandgap circuit is also formed using such a transistor or resistor, the device noise is superimposed on the generated voltage or current. Since the bandgap circuit is able to generate the constant voltage without being affected by the power supply voltage fluctuation or the temperature fluctuation, the bandgap circuit is used as the reference voltage source such as a PLL circuit. When a recent high-accuracy PLL circuit is supplied with the reference voltage generated at the bandgap circuit, the device noise superimposed on the reference voltage may affect a jitter of the PLL circuit, which is a serious problem.

### SUMMARY

A bandgap circuit according to an aspect of the present invention includes a load circuit arranged between an output terminal and a first power supply line, an output transistor arranged between the output terminal and a second power supply line, and outputs a desired reference voltage in accordance with control voltage, a control voltage generating circuit generating the control voltage applied to the output transistor, and a filter arranged between the output transistor and the control voltage generating circuit.

According to the bandgap circuit of the present invention, it is possible to reduce a noise input to a control terminal of the output transistor by the filter connected to a control terminal of the output transistor.

According to the bandgap circuit of the present invention, it is possible to generate a reference voltage having reduced noise.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 shows a circuit diagram of a bandgap circuit according to a first embodiment;

FIG. 2 shows a circuit diagram showing an example of an amplifier according to the first embodiment;

FIG. 3 shows a graph showing a frequency characteristic of an output noise superimposed on an output voltage in the bandgap circuit according to the first embodiment;

FIG. 4 shows a circuit diagram of a bandgap circuit according to a second embodiment;

FIG. 5 shows a graph showing a frequency characteristic of an output noise superimposed on an output voltage in the bandgap circuit according to the second embodiment; and

FIG. 6 shows a circuit diagram of a related bandgap circuit.

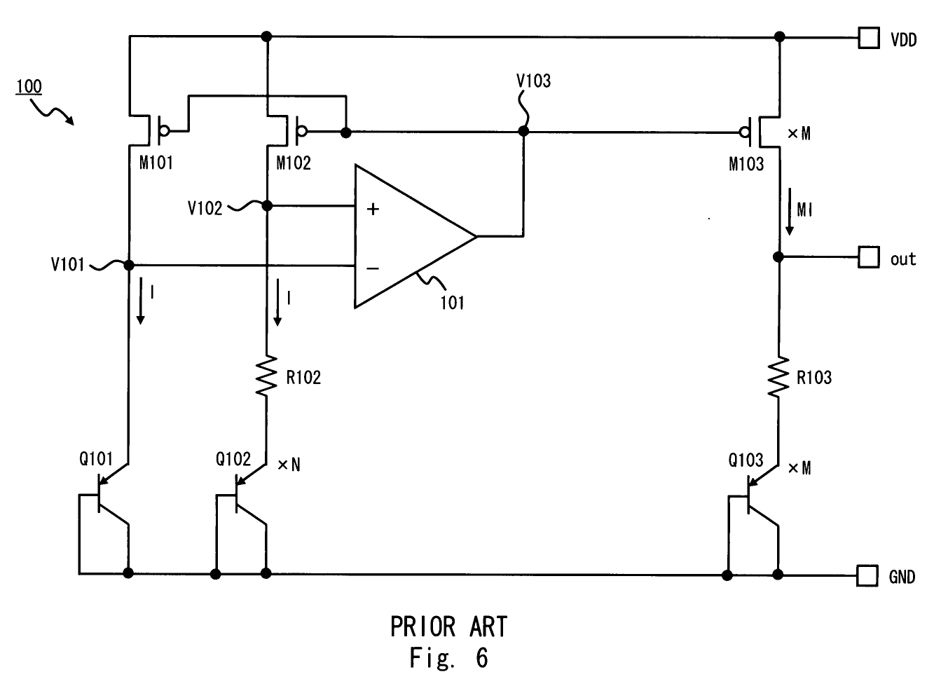

### DETAILED DESCRIPTION OF THE PREFERRED EMBODIMENTS

The invention will now be described herein with reference to illustrative embodiments. Those skilled in the art will recognize that many alternative embodiments can be accomplished using the teachings of the present invention and that the invention is not limited to the embodiments illustrated for explanatory purposes.

### First Embodiment

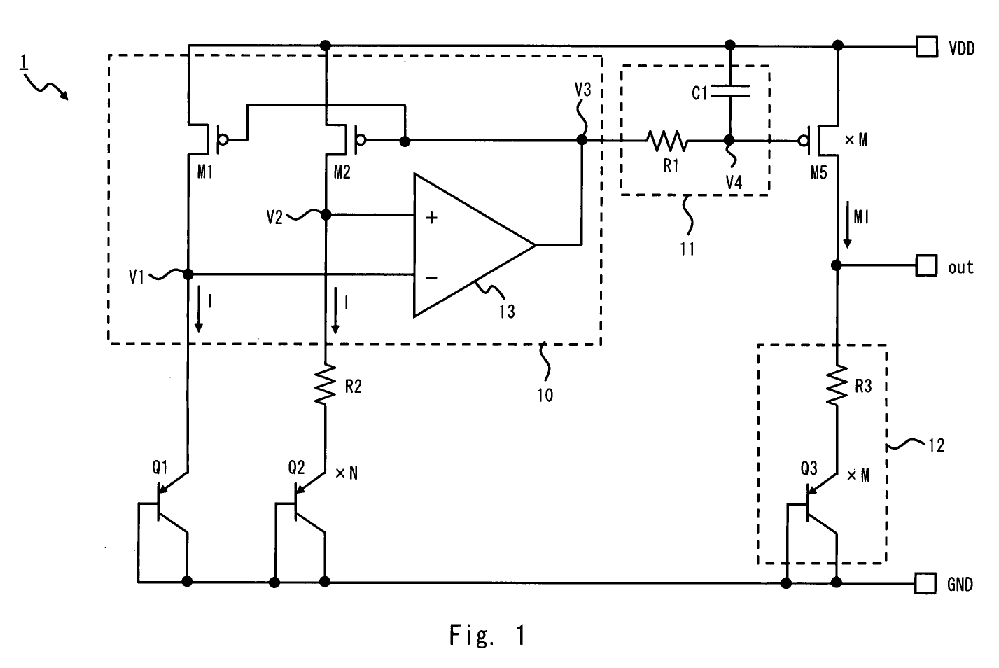

The embodiments of the present invention will be described hereinafter in detail with reference to the drawings. FIG. 1 shows a circuit diagram of a bandgap circuit 1 according to the first embodiment. As shown in FIG. 1, the bandgap circuit 1 includes a first diode element (PNP transistor Q2, for example), a second diode element (PNP transistor Q1, for example), a first resistor (resistor R2, for example), a control voltage generating part 10, a filter 11, an output transistor M5, and a load circuit 12. Note that the bandgap circuit 1 forms a control voltage generating circuit by the PNP transistors Q1 and Q2, the resistor R2, and the control voltage generating part 10.

The PNP transistor Q2 has a diode connection where a base and a collector are connected together. The PNP transistor Q2 includes an emitter (one end) formed by a P-type semiconductor region, a base formed by an N-type semiconductor region, and a collector (the other end) formed by a P-type semiconductor region. The collector of the PNP transistor Q2 is connected to a first power supply line (hereinafter referred to as ground line GND). The emitter of the PNP transistor Q2 is connected to one end of the resistor R2. The other end of the resistor R2 is connected to the control voltage generating part 10. The PNP transistor Q2 functions as a diode setting the P-type semiconductor region of the emitter to an anode and setting the N-type semiconductor region of the base to a cathode.

The PNP transistor Q1 has a diode connection where a base and a collector are connected together. The PNP transistor Q1 includes an emitter (one end) formed by a P-type semiconductor region, a base formed by an N-type semiconductor region, and a collector (the other end) formed by a P-type semiconductor region. The collector of the PNP transistor Q1 is connected to the ground line GND. The emitter of the PNP transistor Q1 is connected to the control voltage generating part 10. The PNP transistor Q1 functions as a diode setting the P-type semiconductor region of the emitter to an anode and setting the N-type semiconductor region of the base to a cathode.

The control voltage generating part 10 includes a first transistor (PMOS transistor M2, for example), a second transistor (PMOS transistor M1, for example), and an amplifier 13. The PMOS transistor M1 includes a source connected to a second power supply line (hereinafter referred to as power supply line VDD), a drain connected to the emitter of the PNP transistor Q1, and a control terminal (gate, for example) connected to an output node (a node V3 in FIG. 1) of the amplifier 13. The node between the drain of the PMOS transistor M1 and the emitter of the PNP transistor Q1 is called node V1. The PMOS transistor M2 includes a source connected to the power supply line VDD, a drain connected to the other end of the resistor R2, and a gate connected to the output node of the amplifier 13. A node between the drain of the PMOS transistor M2 and the other end of the resistor R2 is called node V2. Accordingly, the gate of the PMOS transistor M1 and the gate of the PMOS transistor M2 are connected in common to form a current mirror.

The amplifier 13 includes a non-inverting input terminal, an inverting input terminal, and an amplifier output terminal. The non-inverting input terminal is connected to a node V2, the inverting input terminal is connected to a node V1, and the amplifier output terminal is connected to a node V3. The amplifier 13 controls the control voltage of the node V3 so that the voltage of the node V1 and the voltage of the node V2 are made equal to each other.

The filter 11 includes a second resistor (resistor R1, for example) and a capacitor C1. The resistor R1 is connected between the node V3 and the control terminal (gate, for example) of the output transistor M5. The capacitor C1 is connected to the gate of the output transistor M5 and the power supply line VDD. The capacitor C1 may be connected between the gate of the output transistor M5 and the ground line GND.

The output transistor M5 is a PMOS transistor, for example. Therefore, the output transistor is hereinafter called PMOS transistor M5. The PMOS transistor M5 controls a current flowing between a source and a drain based on the control voltage (voltage of the node V3) input to the gate. The gate of the PMOS transistor M5 is connected to the gates of the PMOS transistors M1 and M2 through the filter 11. The source of the PMOS transistor M5 is connected to the power supply line VDD, and the drain thereof is connected to the output terminal out. It can be considered that the output transistor M5 and the PMOS transistors M1 and M2 form one current mirror since the gates are connected to the output transistor M5 and the PMOS transistors M1 and M2.

The load circuit 12 includes a resistor R3 and a PNP transistor Q3. The PNP transistor Q3 has a diode connection where a base and a collector are connected together. The PNP transistor Q3 includes an emitter formed by a P-type semiconductor region, a base formed by an N-type semiconductor region, and a collector formed by a P-type semiconductor region. Then the collector of the PNP transistor Q3 is connected to the ground line GND. The emitter of the PNP transistor Q1 is connected to one end of the resistor R3. The other end of the resistor R3 is connected to the output terminal out. The PNP transistor Q3 functions as a diode setting the P-type semiconductor region of the emitter to an anode and setting the N-type semiconductor region of the base to a cathode.

In the bandgap circuit 1, a transistor size ratio of the PMOS transistors M1, M2 and, M5 is set so that M1:M2:M5=1:1:M. A transistor size in the MOS-type transistor can be indicated by a value (W/L) obtained by dividing the gate width W of the transistor by the gate length L. In summary, a transistor size ratio in the MOS transistor is the ratio of the value calculated by (W/L) in each transistor. Further, a transistor size ratio of the PNP transistors Q1 to Q3 is set so that Q1:Q2:Q3=1:N:M. A transistor size ratio in the bipolar-type transistor can be indicated by area ratio of emitter region of each transistor. In summary, the transistor size ratio of the PNP transistors Q1 to Q3 can be indicated by emitter area ratio of the PNP transistors Q1 to Q3.

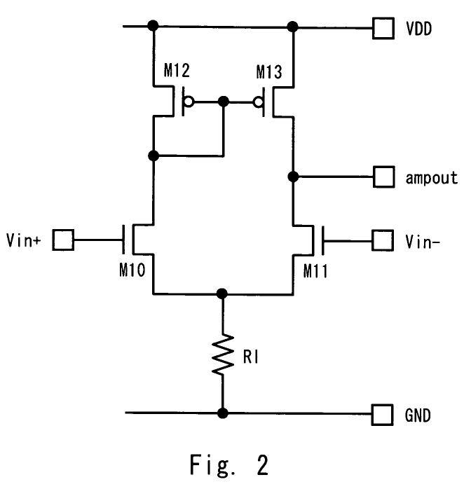

FIG. 2 shows one example of a circuit diagram of an internal circuit of the amplifier 13. As shown in FIG. 2, the amplifier 13 includes a differential pair formed by NMOS transistors M10 and M11. A non-inverting input terminal Vin+ is connected to a gate of the NMOS transistor M10, and an inverting input terminal Vin− is connected to a gate of the NMOS transistor M11. A resistor R1 is connected between a common connecting point of the sources of the NMOS transistors M10 and M11 and the ground line GND. The amplifier 13 operates based on a current flowing in the resistor R1. A PMOS transistor M12 is connected between the drain of the NMOS transistor M10 and the power supply line VDD. A PMOS transistor M13 is connected between the drain of the NMOS transistor M11 and the power supply line VDD. A gate and a drain of the PMOS transistor M12 are connected together, and a gate of the PMOS transistor M12 and a gate of the PMOS transistor M13 are connected in common. Hence, the amplifier 13 has an active load formed by the PMOS transistors M12 and M13. An amplifier output terminal ampout is connected to a connecting point of the drain of the NMOS transistor M11 and the drain of the PMOS transistor M13.

Now, an operation of the bandgap circuit 1 will be described. In the bandgap circuit 1, the PMOS transistor M5 generates a current based on the control voltage generated at the PNP transistors Q1 and Q2, the resistor R2, and the control voltage generating part 10. Then the PMOS transistor M5 flows this current in the load circuit 12 to output the output voltage Vout indicated by the following expression (2):

$$\begin{matrix}Vout = VBE 3 + R 3 \times M \times I \\ = VBE 3 + R 3 \times M \times \frac{1}{R 2} \times \frac{kT}{q} \times ln N\end{matrix} \qquad ( 2 )$$

wherein VBE3 is the voltage between the base and the emitter of the PNP transistor Q3, k is Boltzmann constant, T is an absolute temperature, and q is an elementary charge. VBE3 has a negative temperature coefficient (about −2 mV/K), and the second term has a positive temperature coefficient. Accordingly, constant output voltage can be supplied with respect to the temperature by making the coefficients of the first term and the second term in the expression (2) identical to each other. Since the expression (2) has no term including the power supply voltage, the constant output voltage Vout can be supplied with respect to the power supply voltage as well.

Further, the bandgap circuit 1 decreases the device noise generated by the PNP transistors Q1 and Q2, the resistor R2, and the control voltage generating part 10 using the filter 11. The device noise output from the output terminal out when there is no filter 11 will be described before describing the operation of decreasing the device noise by the filter 11.

First, each noise of the PMOS transistors M1, M2, and M5 is set to Vnm1², Vnm2², Vnm5² respectively. Each noise of the PNP transistors Q1 to Q3 is set to Vnq1², Vnq2², and Vnq3², respectively. Each noise of the resistors R2 and R3 is set to Vnr2², Vnr3², respectively, and the noise of the amplifier 13 is set to Vnamp². A gain from the gate to the drain of the PMOS transistor M1 is G1, a gain from the gate to the drain of the PMOS transistor M2 is G2, and an open loop gain of the amplifier 13 is A. Then the noise Vnout² superimposed on the output voltage Vout is calculated using these values. When the noise at the amplifier output terminal of the amplifier 13 is Vn², then Vn² is expressed by the following expression.

$${Vn}^{2} = {A}^{2} \times \{ Vnq {1}^{2} + Vnq {2}^{2} + Vnr {2}^{2} + {Vnamp}^{2} + G {1}^{2} Vnm {1}^{2} + G {2}^{2} Vnm {2}^{2} + {{Vn}^{2} ( G 2 - G 1 )}^{2} \} \qquad ( 3 )$$

Now, when both sides of the expression (3) are divided by A², then the expression (3) can be transformed into the following expression (4).

$$\frac{{Vn}^{2}}{{A}^{2}} = \{ Vnq {1}^{2} + Vnq {2}^{2} + Vnr {2}^{2} + {Vnamp}^{2} + G {1}^{2} Vnm {1}^{2} + G {2}^{2} Vnm {2}^{2} + {{Vn}^{2} ( G 2 - G 1 )}^{2} \} \qquad ( 4 )$$

Further, both sides are divided by (G2−G1)². If it is assumed that A(G2−G1)>>1, the expression (4) can be expressed by the following expression (5).

$${Vn}^{2} = \frac{\begin{matrix}Vnq {1}^{2} + Vnq {2}^{2} + Vnr {2}^{2} + \\ {Vnamp}^{2} + G {1}^{2} Vnm {1}^{2} + G {2}^{2} Vnm {2}^{2}\end{matrix}}{{( G 2 - G 1 )}^{2}} \qquad ( 5 )$$

Next, G1 which is the gain from the gate to the drain of the PMOS transistor M1 is expressed by the expression (6), and G2 which is the gain from the gate to the drain of the PMOS transistor M2 is expressed by the expression (7). gm1 in the expression (6) is a mutual conductance of the PMOS transistor M1, and gm2 in the expression (7) is a mutual conductance of the PMOS transistor M2.

$$\begin{matrix}G 1 = gm 1 \times \frac{kT}{qI} & ( 6 ) \\ G 2 = gm 2 \times ( \frac{kT}{qI} + R 2 ) & ( 7 )\end{matrix}$$

k is Boltzmann constant [j/k], T is an absolute temperature [K], and q is an elementary charge [c]. In the present embodiment, an output conductance gds1 of the PMOS transistor M1 is set as the expression (8), and an output conductance gds2 of the PMOS transistor M2 is set as the expression (9).

$$\begin{matrix}gds 1 >> \frac{kT}{qI} & ( 8 ) \\ gds 2 >> ( \frac{kT}{qI} + R 2 ) & ( 9 )\end{matrix}$$

Further, in the present embodiment, since the PMOS transistors M1 and M2 have the same transistor size, gm1 and gm2 can be regarded as equal to each other. Accordingly, (G2−G1) can be shown in the expression (10).

G2−G1=gm1×R2 (10)

Further, when a gain from the gate to the drain of the PMOS transistor M5 is G5, and a mutual conductance of the PMOS transistor M5 is gm5, then G5 and gm5 are expressed by the expressions (11) and (12). In the present embodiment, the output conductance gds5 of the PMOS transistor M5 can be set as in the expression (13).

$$\begin{matrix}gm 5 = M \times gm 1 & ( 11 ) \\ G 5 = M \times gm 1 \times ( \frac{kT}{qMI} + R 3 ) & ( 12 ) \\ gds 5 >> ( \frac{kT}{qI} + R 3 ) & ( 13 )\end{matrix}$$

Now, the noise superimposed on the output voltage Vout of the bandgap circuit 1 will be described. When the noise superimposed on the output voltage Vout is Vnout², then this noise can be expressed by the expression (14).

$$\begin{matrix}{Vnout}^{2} = {Vn}^{2} \times G {5}^{2} + Vnm {5}^{2} \times G {5}^{2} + Vnr {3}^{2} + Vnq {3}^{2} \\ = {Vn}^{2} \times {\{ M \times gm 1 \times ( \frac{kT}{qMI} + R 3 ) \}}^{2} + \\ Vnm {5}^{2} \times {\{ M \times gm 1 \times ( \frac{kT}{qMI} + R 3 ) \}}^{2} + \\ Vnr {3}^{2} + Vnq {3}^{2}\end{matrix} \qquad ( 14 )$$

The expression (14) can be considered as the following expression (15) by the expression (13).

Vnout²=Vn²×(M×gm1×R3)²+Vnm5²×(M×gm1×R3)²+Vnr3²+Vnq3² (15)

Further, when the expression (5) and the expression (10) are assigned to the expression (15), then the expression (15) can be expressed by the following expression (16).

$$\begin{matrix}{Vnout}^{2} = \frac{\begin{matrix}Vnq {1}^{2} + Vnq {2}^{2} + Vnr {2}^{2} + \\ {Vnamp}^{2} + G {1}^{2} Vnm {1}^{2} + G {2}^{2} Vnm {2}^{2}\end{matrix}}{{( gm 1 \times R 2 )}^{2}} \times \\ {( M \times gm 1 \times R 3 )}^{2} + Vnm {5}^{2} \times {( M \times gm 1 \times R 3 )}^{2} + \\ Vnr {3}^{2} + Vnq {3}^{2} \\ = ( Vnq {1}^{2} + Vnq {2}^{2} + Vnr {2}^{2} + \\ {Vnamp}^{2} + G {1}^{2} Vnm {1}^{2} + G {2}^{2} Vnm {2}^{2} ) \times {( M \times \frac{R 3}{R 2} )}^{2} + \\ Vnm {5}^{2} \times {( M \times gm 1 \times R 3 )}^{2} + Vnr {3}^{2} + Vnq {3}^{2}\end{matrix} \qquad ( 16 )$$

Note that each noise generated at the transistor, the resistor, and the amplifier shown in the expression (16) can be expressed by the following expressions of (17) to (24).

$$\begin{matrix}Vnq {1}^{2} = Vnq {2}^{2} = 2 {qI ( \frac{kT}{qI} )}^{2} = \frac{2 {( kT )}^{2}}{qI} & ( 17 ) \\ Vnr {2}^{2} = \frac{4 kT}{R 2} \times R {2}^{2} = 4 kT \times R 2 & ( 18 ) \\ \begin{matrix}{Vnamp}^{2} = 2 \times \{ \begin{matrix}( \frac{8 kT}{3 \times gm 10} + \frac{A 10}{L 10 \times W 10 \times {f}^{α10}} ) + \\ {( \frac{gm 12}{gm 10} )}^{2} \times ( \frac{8 kT}{3 \times gm 12} + \frac{A 12}{L 12 \times W 12 \times {f}^{α12}} )\end{matrix} \} \\ = 2 \times \{ \begin{matrix}\frac{8 kT}{3 \times gm 10} \times ( 1 + \frac{gm 12}{gm 10} ) + \\ ( \frac{A 10}{L 10 \times W 10 \times {f}^{α10}} + {( \frac{gm 12}{gm 10} )}^{2} \times \\ \frac{A 12}{L 12 \times W 12 \times {f}^{α12}} )\end{matrix} \}\end{matrix} & ( 19 ) \\ \begin{matrix}G {1}^{2} Vnm {1}^{2} = {( gm 1 \times \frac{kT}{qI} )}^{2} \times ( \frac{8 kT}{3 \times gm 1} + \frac{A 1}{L 1 \times W 1 \times {f}^{α 1}} ) \\ = {( \frac{kT}{qI} )}^{2} \times ( \frac{8 kT \times gm 1}{3} ) + {( gm 1 \times \frac{kT}{qI} )}^{2} \times \frac{A 1}{L 1 \times W 1 \times {f}^{α 1}}\end{matrix} & ( 20 ) \\ \begin{matrix}G {2}^{2} Vnm {2}^{2} = {( gm 2 \times ( \frac{kT}{qI} + R 2 ) )}^{2} \times ( \frac{8 kT}{3 \times gm 2} + \frac{A 2}{L 2 \times W 2 \times {f}^{α2}} ) \\ = {( \frac{kT}{qI} + R 2 )}^{2} \times ( \frac{8 kT \times gm 2}{3} ) + {( gm 2 \times ( \frac{kT}{qI} + R 2 ) )}^{2} \times \\ \frac{A 2}{L 2 \times W 2 \times {f}^{α2}}\end{matrix} & ( 21 ) \\ \begin{matrix}Vnm {5}^{2} {( M \times gm 1 \times R 3 )}^{2} = {( \frac{8 kT}{3 \times M \times gm 1} + \frac{A 5}{L 5 \times W 5 \times {f}^{α5}} )}^{2} \times \\ {( M \times gm 1 \times R 3 )}^{2} \\ = {( \frac{8}{3} kT \times R 3 )}^{2} + {( \frac{A 5 \times M \times gm 1 \times R 3}{L 5 \times W 5 \times {f}^{α5}} )}^{2}\end{matrix} & ( 22 ) \\ Vnr {3}^{2} = \frac{4 kT}{R 3} \times R {3}^{2} = 4 kT \times R 3 & ( 23 ) \\ Vnq {3}^{2} = 2 {qMI ( \frac{kT}{qMI} )}^{2} = \frac{2 {( kT )}^{2}}{qMI} & ( 24 )\end{matrix}$$

The expression (19) shows a noise of the amplifier 13 when the NMOS transistors M10 and M11 forming the amplifier 13 have the same gate length and same gate width and the PMOS transistors M12 and M13 have the same gate length and same gate width. Accordingly, the mutual conductance gm10 of the NMOS transistor M10 and the mutual conductance gm11 of the NMOS transistor M11 are equal to each other. The gate lengths L10 and L11 are equal, and the gate widths W10 and W11 are equal, the coefficients A10 and A11 are equal, and the coefficients a10 and all are equal to each other. The mutual conductance gm12 of the PMOS transistor M12 and the mutual conductance gm13 of the PMOS transistor M13 are equal to each other. The gate lengths L12 and L13 are equal, and the gate widths W12 and W13 are equal, the coefficients A12 and A13 are equal, and the coefficients a12 and a13 are equal to each other. Therefore, in the expression (19), gm10, gm12, M10, M12, L10, L12, A10, A12, a10, and a12 are used to show the value.

gm1 in the expression (20) is a mutual conductance of the PMOS transistor M2, L1 is a gate length of the PMOS transistor M1, W1 is a gate width of the PMOS transistor M1, and A1 and a1 are coefficients of the PMOS transistor M1. gm2 in the expression (21) is a mutual conductance of the PMOS transistor M2, L2 is a gate length of the PMOS transistor M2, W2 is a gate width of the PMOS transistor M2, and A2 and a2 are coefficients of the PMOS transistor M2. M×gm1 in the expression (22) is a mutual conductance gm5 of the PMOS transistor M5, L5 is a gate length of the PMOS transistor M5, W5 is a gate width of the PMOS transistor M5, and A5 and a5 are coefficients of the PMOS transistor M5.

From the above description, when there is no filter 11, the noise shown in the expression (16) is superimposed on the voltage value shown in the expression (5) in the output voltage Vout. The filter 11 decreases the noise shown in the first term of the expression (16). The filter 11 has a transfer function shown in the following expression (25):

$$\vert V 4 \vert = \frac{1}{\sqrt{1 + {ϖ}^{2} C {1}^{2} R {1}^{2}}} \vert V 3 \vert \qquad ( 25 )$$

wherein V4 is a voltage value of the node V4, V3 is a voltage value of the node V3, ω is a value shown in ω=2 pf, and f is a frequency of the noise. In summary, the filter 11 tends to reduce noise having higher frequency.

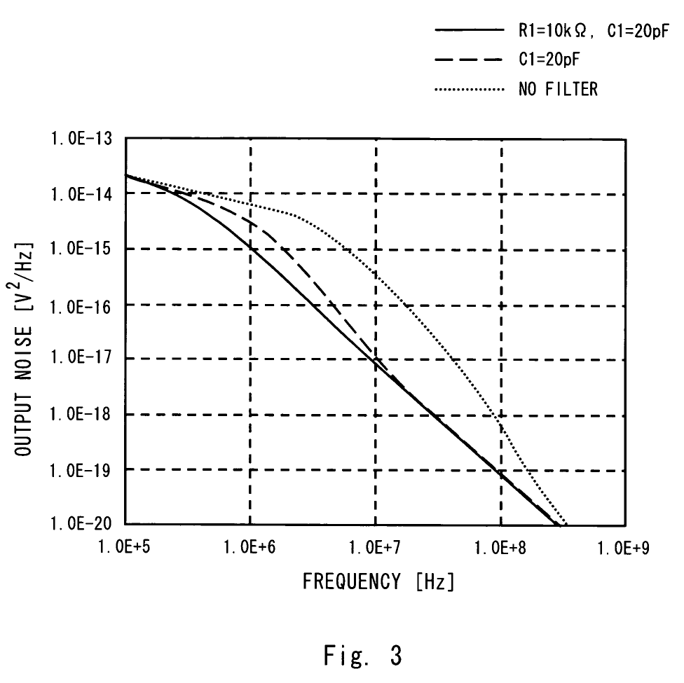

Now, FIG. 3 shows a graph of one example of a relation between the output noise superimposed on the output voltage Vout and the frequency when the filter 11 is used. In the graph shown in FIG. 3, a vertical axis shows the output noise by a logarithmic axis, and a horizontal axis shows the frequency of the output noise. In FIG. 3, data where the filter 11 is formed only by the capacitor C1 and data where there is no filter 11 are also shown for the purpose of reference.

As shown in FIG. 3, by employing the filter 11, the output noise having frequency of around 10 MHz can be reduced by about 1/70 compared with the case where there is no filter 11. The output noise of other frequency bands can further be reduced as well by employing the filter 11 rather than a case where the filter 11 is not employed. On the other hand, the output noise can be reduced even when the filter 11 is formed only by the capacitor C1. However, if the value of the capacitor C1 is the same, it is desirable to form the filter 11 by the resistor R1 and the capacitor C1 since the output noise can further be reduced. Even if the filter 11 is formed only by the capacitor C1, it is possible to reduce as much noise as in the case where the filter 11 is formed by the resistor R1 and the capacitor C1 by doubling the value of the capacitor C1, for example.

As will be clear from the above description, the bandgap circuit 1 according to the present embodiment is able to decrease the output noise by having the filter 11 between the gate of the output transistor and the control voltage generating part 10. Then, it is possible to realize high noise reducing ability by forming the filter 11 by the resistor and the capacitor without increasing capacitance value of the capacitor. In other words, it is possible to realize high noise removing ability while minimizing the size of the capacitor with respect to the circuit. Since the size of the capacitor is generally far larger than that of the resistor, the circuit size can efficiently be reduced by suppressing the increase in the size of the capacity.

The bandgap circuit 1 according to the present embodiment can also reduce power consumption. As shown in the expressions (17) to (24), when the device noises of the transistor and the resistor are reduced, current flowing in the device has to be increased. For example, when the device noise of the PNP transistor shown in the expression (17) is reduced by 1/10, the current flowing in the transistor needs to be increased by ten times. However, since the bandgap circuit 1 according to the present embodiment decreases the device noise by the filter 11, it is possible to decrease the device noise without increasing the power consumption of the circuit.

Although the device noise can also be reduced by making the first term indicated by M×(R3/R2) in the expression (16) smaller, this term relates to temperature characteristic of the output voltage Vout. Accordingly, if this value is made smaller, the output voltage Vout is more likely to be affected by the temperature fluctuation. Hence, to make the term indicated by M×(R3/R2) smaller is not appropriate for the purpose of realizing the constant output voltage Vout.

### Second Embodiment

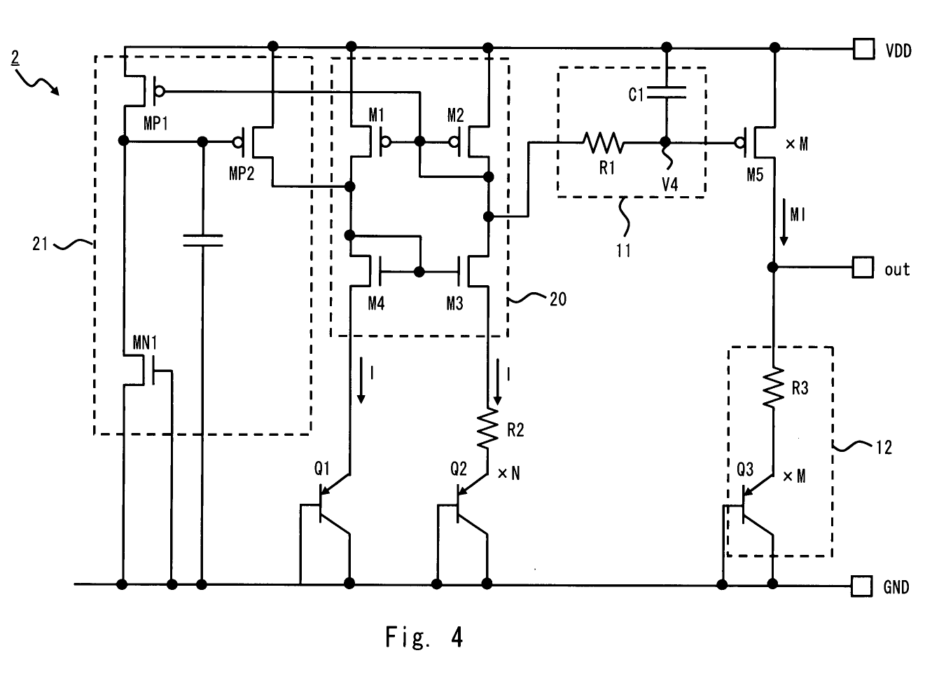

FIG. 4 shows a circuit diagram of the bandgap circuit 2 according to the second embodiment. The bandgap circuit 2 includes a control voltage generating part 20 in place of the control voltage generating part 10. The control voltage generating part 20 sets current flowing in the PMOS transistors M1 and M2 by two transistors without employing the amplifier 13. The control voltage generating part 20 includes a third transistor (NMOS transistor M4, for example) and a fourth transistor (NMOS transistor M3, for example) in place of the amplifier 13. The bandgap circuit 2 includes an activation circuit 21.

The NMOS transistor M3 has a source connected to the resistor R1, a drain connected to the PMOS transistor M2, and a gate connected to the NMOS transistor M4. The NMOS transistor M4 has a source connected to an emitter of the PNP transistor Q1, and a gate and a drain connected in common. In summary, the NMOS transistors M3 and M4 form a current mirror.

In the bandgap circuit 2, the transistor size of the NMOS transistors M3 and M4 are set to be equal to each other. Therefore, the NMOS transistors M3 and M4 generate current in which the voltage of the sources are equal to each other. Then current generated at the NMOS transistors M3 and M4 is supplied to the PMOS transistors M1 and M2. Since the gate and the drain of the PMOS transistor M2 are connected in common in this embodiment, the current that is the same as that generated at the NMOS transistors M3 and M4 flows in the PMOS transistor M1, and the output transistor flows current M times larger than the current generated at the NMOS transistors M3 and M4.

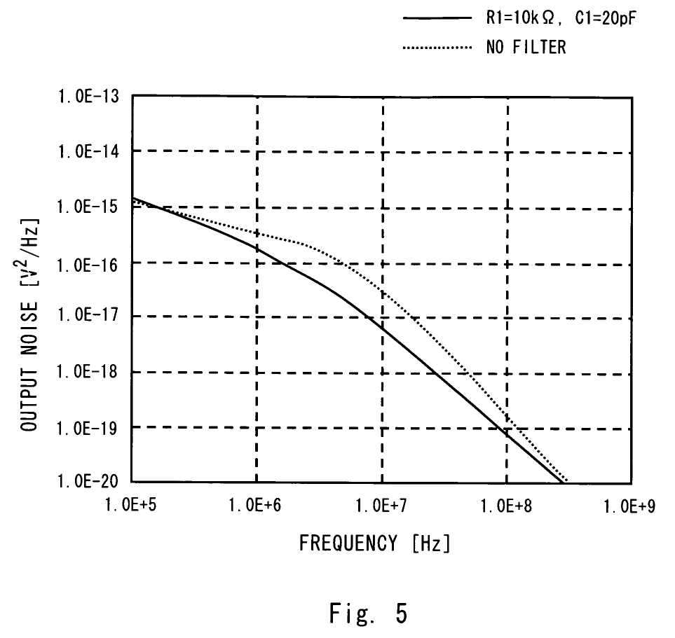

Although there is provided an activation circuit 21 in the present embodiment, the activation circuit 21 starts to operate immediately after the bandgap circuit 2 is turned on, and helps activate the bandgap circuit 2. The activation circuit 21 shown in FIG. 5 is one example of the activation circuit, and the activation circuit 21 can be replaced with other configurations.

The bandgap circuit 2 is a deformation example of the bandgap circuit 1. Even with the bandgap circuit 2, the device noise can be reduced as well as in the bandgap circuit 1 since the bandgap circuit 2 includes the filter 11. FIG. 5 shows one example of a relation between the output noise superimposed on the output voltage Vout and the frequency in the bandgap circuit 2 in order to show a noise reducing effect of the bandgap circuit 2. In a graph shown in FIG. 5, a vertical axis shows the output noise by a logarithmic axis, and a horizontal axis shows the frequency of the output noise. FIG. 5 also shows data when there is no filter 11 provided for the purpose of reference. As shown in FIG. 5, even in the bandgap circuit 2, the amplitude of the output noise can further be reduced by employing the filter 11 rather than a case where there is no filter 11.

Since the output noise reducing effect can be obtained by the filter 11 also in the bandgap circuit 2, there is no need to increase the current in order to decrease the device noise.

It is apparent that the present invention is not limited to the above embodiments, but may be modified and changed without departing from the scope and spirit of the invention. For example, the PNP transistors Q1 to Q3 may be formed by NPN transistors or may simply be formed by diodes. The components formed by the MOS transistors may also be replaced with bipolar transistors.

What is claimed is:

1. A bandgap circuit comprising:
a load circuit arranged between an output terminal and a first power supply line;
an output transistor arranged between the output terminal and a second power supply line, and outputs a desired reference voltage in accordance with control voltage;
a control voltage generating circuit generating the control voltage applied to the output transistor; and
a filter arranged between the output transistor and the control voltage generating circuit.

2. The bandgap circuit according to claim 1, wherein
the control voltage generating circuit further comprises:
a first diode element having one end connected to the first power supply line;
a first resistor having one end connected to the other end of the first diode element;
a second diode element having one end connected to the first power supply line and having a different size than the size of the first diode element; and
a control voltage generating part generating the control voltage based on a first potential generated at the other end of the first resistor and a second potential generated at the other end of the second diode element.

3. The bandgap circuit according to claim 2, wherein the filter has a second resistor and a capacitor, the second resistor having one end connected to the control voltage generating part and the other end connected to a gate of the output transistor, and the capacitor being connected between the other end of the second resistor and the first power supply line or the second power supply line.

4. The bandgap circuit according to claim 3, wherein the control voltage generating part supplies substantially the same current to the first and second diode elements based on the first potential and the second potential, the control voltage generating part includes first and second transistors where control terminals are connected in common, and the control voltage is applied to the control terminals of the first and second transistors.

5. The bandgap circuit according to claim 2, wherein the control voltage generating part comprises:
a first transistor connected to the other end of the first resistor and the second power supply line;
a second transistor connected between the other end of the second diode element and the second power supply line; and
an amplifier having a non-inverting input terminal connected to the other end of the first resistor and an inverting input terminal connected to the other end of the second diode element, wherein
an output of the amplifier is applied to control terminals of the first and second transistors so that the amplifier outputs the control voltage.

6. The bandgap circuit according to claim 2, wherein the control voltage generating part further comprises first to fourth transistors including control terminals, sources, and drains, wherein
the first transistor has a control terminal and a drain connected in common and a source connected to the second power supply line,
the second transistor has a control terminal connected to the control terminal of the first transistor in common and a source connected to the second power supply line,
the third transistor has a control terminal and a drain connected in common, a source connected to the other end of the second diode element, and a drain connected to the drain of the second transistor,
the fourth transistor has a control terminal connected to the control terminal of the third transistor in common, a source connected to the other end of the first resistor, and a drain connected to the drain of the first transistor, and
the control voltage generating part outputs the voltage of the control terminals of the first and second transistors as the control voltage.

7. The bandgap circuit according to claim 2, wherein the control voltage generating part comprises:
a first transistor having a drain connected to the other end of the first resistor; and
a second transistor having a drain connected to the other end of the second diode element, wherein
the control voltage generating part forms a current mirror where a gate of the first transistor and a gate of the second transistor are connected in common.

8. The bandgap circuit according to claim 7, wherein
the control voltage generating part comprises an amplifier generating the control voltage supplied to gates of the first and second transistors based on a first potential generated at the other end of the first resistor and a second potential generated at the other end of the second diode element.

9. The bandgap circuit according to claim 2, wherein the control voltage generating part comprises:
a first transistor having a control terminal and a drain connected in common and a source connected to the second power supply line;
a second transistor having a control terminal connected to the control terminal of the first transistor in common and a source connected to the second power supply;
a third transistor having a control terminal and a drain connected in common, a source connected to the other end of the second diode element, and a drain connected to the drain of the second transistor; and
a fourth transistor having a control terminal connected to the control terminal of the third transistor in common, a source connected to the other end of the first resistor, and a drain connected to the drain of the first transistor, wherein
the control voltage generating part forms a current mirror where a gate of the first transistor and a gate of the second transistor are connected in common, and
the third and fourth transistors set values of current flowing in the first and second transistors and the output transistor based on the current generated according to a first potential generated at the other end of the first resistor and a second potential generated at the other end of the second diode element.
